(19) United States
(12) Patent Application Publication
(10) Pub. No.: US 2024/0309688 A1
(43) Pub. Date: Sep. 19, 2024

(54) SLIDING DOOR DEVICE FOR VEHICLE

(71) Applicants: Hyundai Motor Company, Seoul (KR); Kia Corporation, Seoul (KR); KWANGJIN CO. LTD., Asan-si (KR)

(72) Inventors: Jaeseung LEE, Hwaseong-Si (KR); Jinsu JANG, Asan-si (KR); Taeyong JEON, Asan-si (KR)

(73) Assignees: Hyundai Motor Company, Seoul (KR); Kia Corporation, Seoul (KR); KWANGJIN CO. LTD., Asan-si (KR)

(21) Appl. No.: 18/367,892

(22) Filed: Sep. 13, 2023

(30) Foreign Application Priority Data
Mar. 14, 2023 (KR) 10-2023-0033379

(51) Int. Cl. E05D 15/10; B60J 5/06

(52) U.S. Cl. CPC E05D 15/101; B60J 5/062; E05D 2015/1026

(57) ABSTRACT

A sliding door device for a vehicle is provided at a lateral side of a chassis cab of a vehicle to slide in a longitudinal direction of the vehicle and configured to open or close an opening formed in the chassis cab and includes: a pair of sliding rails provided on at least one of upper and lower portions of the chassis cab, extending in the longitudinal direction of the vehicle, and each including a shape curved rearward toward the cab frame, and doors configured to be slidable along the sliding rails and positioned so that upper-end surfaces thereof are positioned without a level difference from an upper-end surface of the chassis cab in a state in which the doors are not slid, the doors being positioned so that the upper-end surfaces thereof protrude outwardly from the upper-end surface of the chassis cab in a state in which the doors are slid.

### CROSS-REFERENCE TO RELATED APPLICATION

The present application claims priority to Korean Patent Application No. 10-2023-0033379 filed on Mar. 14, 2023, the entire contents of which is incorporated herein for all purposes by this reference.

### BACKGROUND OF THE PRESENT DISCLOSURE

### Field of the Present Disclosure

The present disclosure relates to a sliding door device for a vehicle, and more particularly, to a sliding door device for a vehicle, which is configured to open or close a door opening portion of a vehicle body while sliding and swinging forward or rearward in a longitudinal direction of a vehicle.

### Description of Related Art

In general, as illustrated in FIG. 1, a delivery vehicle has a chassis cab 2 provided rearward of a driver seat 1 and configured to store items. A lateral side of the chassis cab 2 may be opened or closed by a front sliding door 3 and a rear sliding door 4. The lateral side of the chassis cab 2 is opened as the front sliding door 3 moves rearward in a state in which the rear sliding door 4 is stationary. Alternatively, the lateral side of the chassis cab 2 is opened as the rear sliding door 4 moves forward in a state in which the front sliding door 3 is stationary.

The bidirectional sliding door has the advantage of being inexpensive, lightweight, and simple to open or close. However, the bidirectional sliding doors are structured to slide in a state in which the two doors 3 and 4 overlap each other, which causes a problem in that a loading space in the chassis cab 2 decreases to that extent. Furthermore, because an opening width may be ensured only by a width of one door, it is difficult to load or unload items into or from the chassis cab 2 in case that the items are large in volume. Furthermore, it is not easy to ensure watertightness between the front sliding door 3 and the rear sliding door 4.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a sliding door for a vehicle, which is provided at a lateral side of a chassis cab of a vehicle and is configured for sliding and swinging, which may suppress a loss of an item storage space and ensure an opening width.

Various aspects of the present disclosure are directed to providing a sliding door device for a vehicle, which is provided at a lateral side of a chassis cab of a vehicle to slide in a longitudinal direction of the vehicle and configured to open or close an opening formed in the chassis cab, the sliding door device including: a pair of sliding rails provided on at least one of upper and lower portions of the chassis cab, extending in the longitudinal direction of the vehicle, and each being curved rearward toward the cab frame; and doors configured to be slidable along the sliding rails and positioned so that upper-end surfaces thereof are positioned without a level difference from an upper-end surface of the chassis cab in a state in which the doors are not slid, the doors being positioned so that the upper-end surfaces thereof protrude outwardly from the upper-end surface of the chassis cab in a state in which the doors are slid.

The pair of sliding rails may include an internal rail provided inside the vehicle, and an external rail provided outside the vehicle and extending in a direction parallel to the internal rail.

The internal rail may include a curved shape and include a larger curvature than the external rail.

A door arm sliding assembly may be provided on the upper portion or the lower portion of the chassis cab and configured to be coupled to or decoupled from the door, and the door arm sliding assembly may be slidable along the sliding rail.

The door arm sliding assembly may include: a door arm configured to move along the sliding rail; and a door arm bracket connected to the door arm and configured to be fixed to or released from the door.

A door roller may be provided on a lower surface of the door arm and contacts with the sliding rail and roll in accordance with a sliding motion of the door.

The door may include a sliding handle portion that operates the door so that the door slides along the sliding rail or does not slide.

The door may include a door fixing bar configured to move in a longitudinal direction of a vehicle body so that the door is fixed to or released from the door arm sliding assembly in conjunction with an operation of the sliding handle portion.

A cable may be connected to the door fixing bar, and the cable may move the door fixing bar in the longitudinal direction of the vehicle body when tension is applied to the cable by operation of the sliding handle portion.

The door fixing bar may include a plurality of locking pins, and the locking pin may be coupled to or decoupled from the door arm sliding assembly by a movement of the door fixing bar.

The plurality of locking pins may be inserted into or released from a locking pinhole provided in a door arm bracket of the door arm sliding assembly.

The doors may include first and second doors, and any one of the first door and the second door may slide and overlap the other door.

The door arm sliding assemblies may be respectively provided on the first door and the second door, and a stopper may be provided on the door arm sliding assembly to restrict a sliding motion of the opposite door.

Various aspects of the present disclosure are directed to providing a sliding door device for a vehicle, which is provided at a lateral side of a chassis cab of a vehicle to slide in a longitudinal direction of the vehicle and configured to open or close an opening formed in the chassis cab, the sliding door device including: a first door and a second door connected to be slidable in the longitudinal direction of the vehicle along sliding rails provided on at least one of upper and lower portions of the chassis cab so that the first door and the second door overlap each other, in which end portions of the first door and the second door, which face each other, have inclined shapes, the first door and the second door are positioned so that upper-end surfaces thereof are positioned without a level difference from an upper-end surface of the chassis cab in a state in which the first door and the second door are not slid, and the first door and the second door are positioned so that the upper-end surfaces thereof protrude outwardly from the upper-end surface of the chassis cab in a state in which the first door and the second door are slid.

A B-pillar may be provided on a center portion of the chassis cab, and the B-pillar may extend in an upward and downward direction of the vehicle body and be configured to be detached from the chassis cab or rotate.

An upper-end surface of the B-pillar may include an inclined shape corresponding to the shapes of the upper-end surfaces of the end portions of the first door and the second door.

The end portions of the first door and the second door, which face each other, may be coupled to the B-pillar with a door seal interposed therebetween.

According to the exemplary embodiment of the present disclosure, the door, which may slide and swing, is applied to the vehicle including the chassis cab configured for storing items. Therefore, the door open regions may be diversified, and the door opening width may be maximized so that items with various sizes may be loaded or unloaded, improving the usability.

Furthermore, the door may slide along the sliding rail including a curved shape, which may minimize a loss of the item storage space in the chassis cab and allow the item storage space to store a larger number of items.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a process of opening a door of a vehicle including a chassis cab in the related art.

FIG. 2 is a view exemplarily illustrating a vehicle to which a sliding door device for a vehicle according to various exemplary embodiments of the present disclosure is applied.

FIG. 3 is a view exemplarily illustrating a state in which a door of the sliding door device for a vehicle according to the exemplary embodiment of the present disclosure slides.

FIG. 4 is a view exemplarily illustrating a state in which the door of the sliding door device for a vehicle according to the exemplary embodiment of the present disclosure swings.

FIG. 5 is a view exemplarily illustrating the sliding door device for a vehicle according to the exemplary embodiment of the present disclosure.

FIG. 6 is a perspective view exemplarily illustrating a state in which a door arm sliding assembly is provided in the sliding door device for a vehicle according to the exemplary embodiment of the present disclosure.

FIG. 7 is a perspective view exemplarily illustrating the door arm sliding assembly of the sliding door device for a vehicle according to the exemplary embodiment of the present disclosure.

FIG. 8 is a top plan view exemplarily illustrating a state in which the door arm sliding assemblies of the sliding door device for a vehicle according to the exemplary embodiment of the present disclosure are provided at two opposite sides of the door when viewed from the upper side thereof.

FIG. 9 is a view exemplarily illustrating a process in which a door striker and a door latch of the sliding door device for a vehicle according to the exemplary embodiment of the present disclosure are released.

FIG. 10 is a view exemplarily illustrating a process in which a hinge catcher of the sliding door device for a vehicle according to the exemplary embodiment of the present disclosure is released from a door frame.

FIG. 11 is a cross-sectional view taken along line ‘C-C’ in FIG. 5.

FIG. 12 is a cross-sectional view taken along line ‘B-B’ in FIG. 5.

FIG. 13 is a cross-sectional view taken along line ‘D-D’ in FIG. 5.

FIG. 14 is a cross-sectional view taken along line ‘A-A’ in FIG. 5.

FIG. 15A, FIG. 15B, FIG. 15C, FIG. 15D, FIG. 15E, FIG. 15F and FIG. 15G are views exemplarily illustrating a process in which the door of the sliding door device for a vehicle according to the exemplary embodiment of the present disclosure slides.

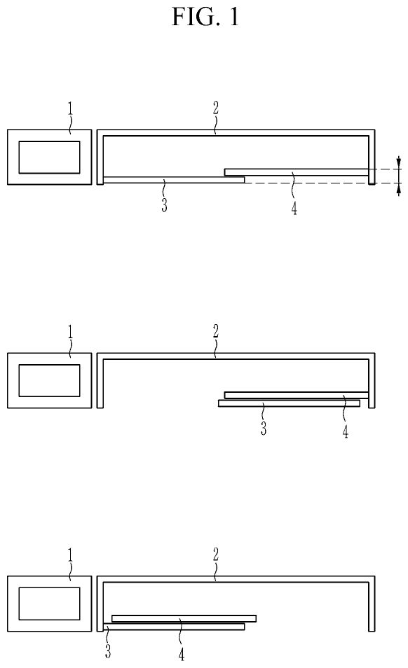

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments of the present disclosure will be described in detail with reference to the accompanying drawings so that those with ordinary skill in the art to which an exemplary embodiment of the present disclosure pertains may easily carry out the embodiments. The present disclosure may be implemented in various different ways and is not limited to the exemplary embodiments described herein.

Furthermore, the constituent elements including the same configurations in several embodiments will be assigned with the same reference numerals and described only in the representative embodiment, and only the constituent elements, which are different from the constituent elements according to the representative embodiment, will be described in other exemplary embodiments of the present disclosure.

It is noted that the drawings are schematic and are not illustrated based on actual scales. Relative dimensions and proportions of parts illustrated in the drawings are exaggerated or reduced in size for clarity and convenience in the drawings, and any dimension is just illustrative but not restrictive. The same reference numerals designate the same structures, elements or components illustrated in two or more drawings to exhibit similar characteristics. When one component is described as being positioned “above” or “on” another component, one component may be positioned “directly on” another component, and one component can also be positioned on another component with other components interposed therebetween.

The exemplary embodiment of the present disclosure specifically illustrates an example of the present disclosure. As a result, various modifications of the drawings are expected. Therefore, the exemplary embodiments are not limited to specific forms in regions illustrated in the drawings, and for example, include modifications of forms by the manufacture thereof.

Hereinafter, a structure of a sliding door device for a vehicle according to various exemplary embodiments of the present disclosure will be described in detail with reference to the accompanying drawings.

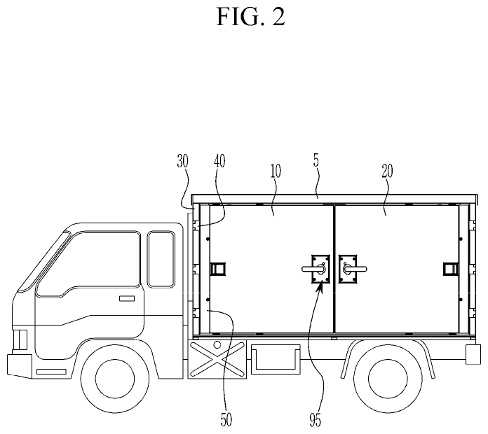

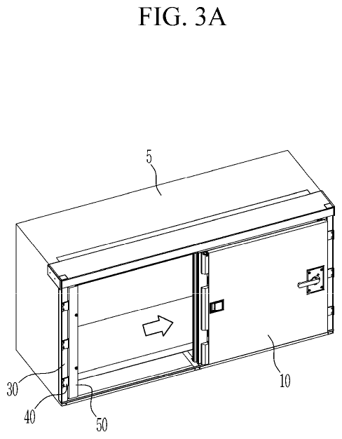

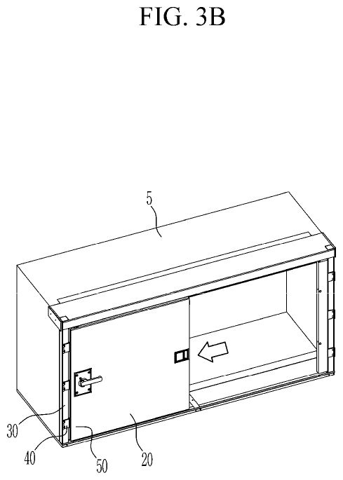

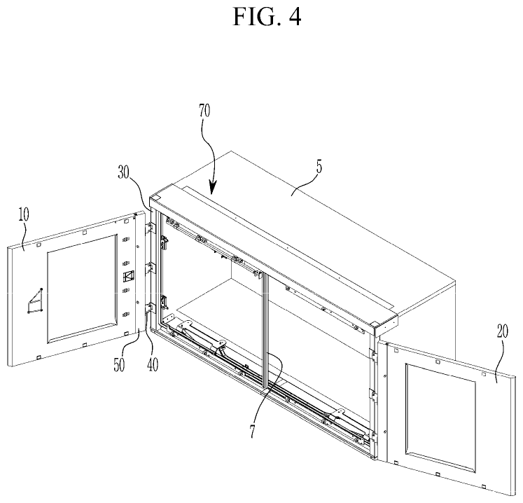

FIG. 2 is a view exemplarily illustrating a vehicle to which a sliding door device for a vehicle according to various exemplary embodiments of the present disclosure is applied, FIG. 3 is a view exemplarily illustrating a state in which a door of the sliding door device for a vehicle according to the exemplary embodiment of the present disclosure slides, and FIG. 4 is a view exemplarily illustrating a state in which the door of the sliding door device for a vehicle according to the exemplary embodiment of the present disclosure swings.

With reference to FIG. 2, FIG. 3 and FIG. 4, a sliding door device for a vehicle according to various exemplary embodiments of the present disclosure may be provided at a lateral side of a chassis cab 5 of a vehicle in a slidable/swingable manner and open or close an opening formed at the lateral side of the chassis cab 5.

The sliding door device for a vehicle according to the exemplary embodiment of the present disclosure includes a first door 10 and a second door 20. The first door 10 and the second door 20 may be hingedly and rotatably connected to cab frames 30 provided at two opposite sides of the chassis cab 5 so that the first door 10 and the second door 20 may slide between the cab frames 30.

As illustrated in FIG. 3A, the first door 10 may slide toward the second door 20 which is stationary. As illustrated in FIG. 3B, the second door 20 may slide toward the first door 10 which is stationary. That is, the door, which slides, may be moved toward an upper surface of the door which is stationary. The first door 10 and the second door 20 may be connected to sliding rails 90 provided on upper and lower portions of the chassis cab 5 so that the first door 10 and the second door 20 may slide along the sliding rails 90. In a state in which the first door and the second door 10 and 20 are not slid, the first door and the second door 10 and 20 may be positioned so that upper-end surfaces thereof are positioned without a level difference from an upper-end surface of the chassis cab 5. In a state in which the first door and the second door 10 and 20 are slid, the first door and the second door 10 and 20 may be positioned so that the upper-end surfaces thereof protrude outwardly from the upper-end surface of the chassis cab 5.

As illustrated in FIG. 4, the first door 10 and the second door 20 may be hingedly and rotatably connected to the cab frames 30 provided at the lateral side of the chassis cab 5. To the present end, door frames 50 may be provided at positions corresponding to the cab frames 30. The door frames 50 may be connected to an end portion of the first door 10 and an end portion of the second door 20. The door frames 50 may be connected to the cab frames 30 by door hinges 40. The door frames 50 hingedly rotate relative to the cab frames 30 by the door hinges 40 so that the first door 10 and the second door 20 may swing.

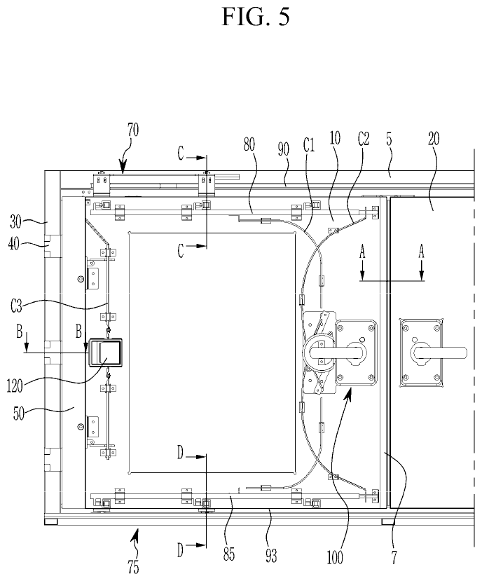

FIG. 5 is a view exemplarily illustrating the sliding door device for a vehicle according to the exemplary embodiment of the present disclosure.

With reference to FIG. 5, the sliding door device for a vehicle according to the exemplary embodiment of the present disclosure includes the cab frames 30 provided at the two opposite sides of the chassis cab 5, and the sliding rails 90 and 93 provided at the upper and lower portions of the chassis cab 5.

The door frames 50 may be provided at the positions corresponding to the cab frames 30. The door frames 50 may be coupled to or decoupled from the end portion of the first door 10 and the end portion of the second door 20. The door hinge 40 may be provided on the cab frame 30 and connected to the door frame 50. The door frame 50 may hingedly rotate relative to the cab frame 30 by the door hinge 40.

Furthermore, door strikers 62 may be provided on the door frames 50. Door latches 60 may be provided on the first door 10 and the second door 20 and disposed at positions corresponding to the door strikers 62. The door latch 60 may be coupled to or decoupled from the door striker 62. When the doors 10 and 20 swing, the door strikers 62 and the door latches 60 may be kept in coupled states. When the doors 10 and 20 slide, the door strikers 62 and the door latches 60 may be decoupled.

Door arm sliding assemblies 70 and 75 may be provided on the upper or lower portions of the chassis cab 5. The door arm sliding assemblies 70 and 75 may be coupled to or decoupled from the first door 10 and the second door 20 and configured to slide along the sliding rails 90 and 93.

When the doors 10 and 20 slide, the door arm sliding assemblies 70 and 75 are kept coupled to the doors 10 and 20. When the doors 10 and 20 swing, the door arm sliding assemblies 70 and 75 are decoupled from the doors 10 and 20. To the present end, door fixing bars 80 and 85 may be provided on the first door and the second door 10 and 20. The door fixing bars 80 and 85 may move in a longitudinal direction of a vehicle body so that the first door and the second door 10 and 20 may be fixed to or released from the door arm sliding assemblies 70 and 75. That is, when the doors 10 and 20 slide, the door fixing bars 80 and 85 are coupled to the door arm sliding assemblies 70 and 75. When the doors 10 and 20 swing, the door fixing bars 80 and 85 are decoupled from the door arm sliding assemblies 70 and 75.

The first door and the second door 10 and 20 have swing handle portions 120 that operate the first door and the second door 10 and 20 so that the first door and the second door 10 and 20 swing about the cab frames 30 or do not swing. The first door and the second door 10 and 20 have sliding handle portions 100 that operate the first door and the second door 10 and 20 so that the first door and the second door 10 and 20 may slide or may not slide.

The sliding handle portions 100 rotate to move the door fixing bars 80 and 85 in the longitudinal direction of the vehicle body so that the door fixing bars 80 and 85 are decoupled from the door arm sliding assemblies 70 and 75. Furthermore, for example, the swing handle portions 120 are pulled so that the end portions of the doors 10 and 20 are decoupled from the door frames 50.

Cables C1 and C2 may be connected to the sliding handle portion 100 and the door fixing bars 80 and 85. Tension is applied to the cables C1 and C2 when the sliding handle portion 100 rotates so that the door fixing bars 80 and 85 may move.

Furthermore, cables C3 and C4 are provided on the swing handle portion 120 and connected to a hinge catcher 122. Tension is applied to the cables C3 and C4 by operation of the swing handle portion 120 so that the hinge catcher 122 may move in a direction perpendicular to the longitudinal direction of the vehicle body.

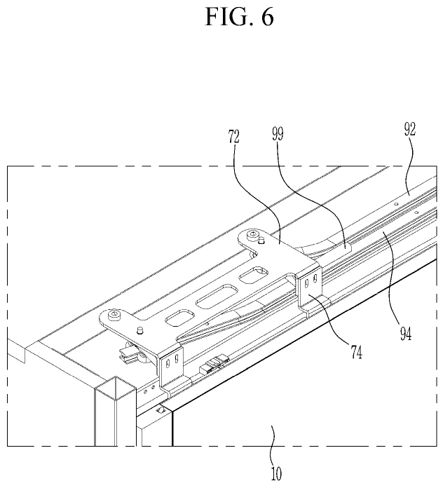

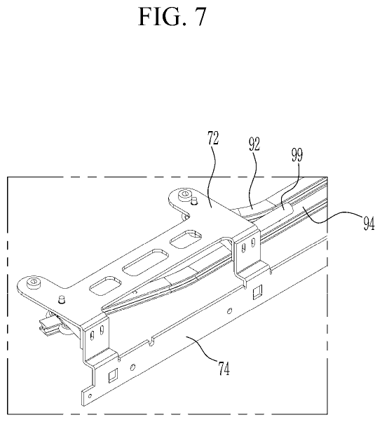

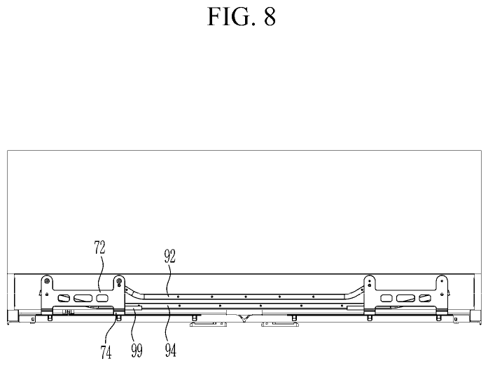

FIG. 6 is a perspective view exemplarily illustrating a state in which a door arm sliding assembly is provided in the sliding door device for a vehicle according to the exemplary embodiment of the present disclosure, FIG. 7 is a perspective view exemplarily illustrating the door arm sliding assembly of the sliding door device for a vehicle according to the exemplary embodiment of the present disclosure, and FIG. 8 is a top plan view exemplarily illustrating a state in which the door arm sliding assemblies of the sliding door device for a vehicle according to the exemplary embodiment of the present disclosure are provided at two opposite sides of the door when viewed from the upper side thereof.

With reference to FIGS. 6 to 8, the door arm sliding assemblies 70 and 75 may be provided on the upper and lower portions of the chassis cab 5, and the door arm sliding assemblies 70 and 75 may slide along the sliding rails 90 and 93.

The door arm sliding assembly 70 includes a door arm 72 and a door arm bracket 74. A door roller 73 provided on a lower surface of the door arm 72 may roll by being in contact with the sliding rail. The sliding rails 92 and 94 may be provided as a pair of sliding rails 96 and 98 and each include a shape curved rearward toward the cab frame 30.

The sliding rails 92 and 94 may include an internal rail 92 provided inside the vehicle, and an external rail 94 provided outside the vehicle and extending in a direction parallel to the internal rail 92. In the instant case, the internal rail 92 may include a curved shape and include a larger curvature than the external rail 94.

The door arm sliding assemblies 70 and 75 may be respectively provided at the upper and lower sides of the first door and the second door 10 and 20. Stoppers 99 may be respectively provided on the door arm sliding assemblies 70 and 75 to restrict the sliding motion of the opposite door. The stopper 99 may be provided on a lower surface of the door arm 72 of each of the door arm sliding assemblies 70 and 75 and protrude toward a portion where the first door 10 and the second door 20 meet together. The stopper 99 may stop the sliding motion of the door while coming into contact with a lateral end portion of the door arm 72 of the opposite door.

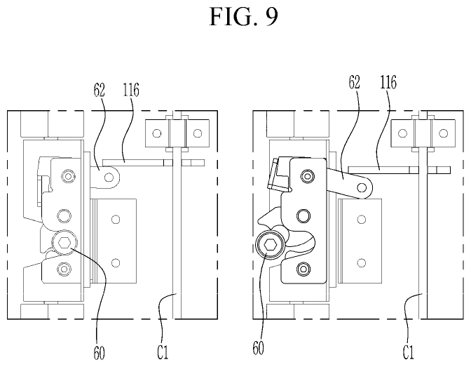

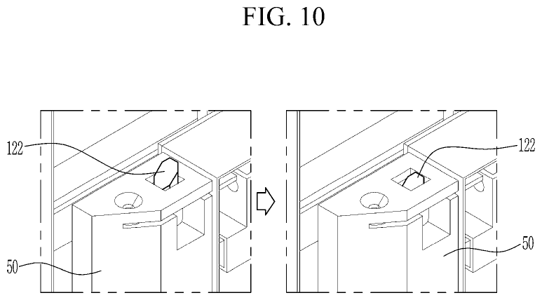

FIG. 9 is a view exemplarily illustrating a process in which a door striker and a door latch of the sliding door device for a vehicle according to the exemplary embodiment of the present disclosure are released.

With reference to FIG. 9, a lever 116 is provided on the cables C3 and C4. The lever 116 is brought into contact with the door striker 62 by the movements of the cables C3 and C4 and rotates the door striker 62 so that the door striker 62 may be decoupled from the door latch 60.

When the cables C3 and C4 are moved, the lever 116 also moves in the same direction, and the lever 116 comes into contact with and pushes the door striker 62 provided on the door frame 50. In the instant case, the door striker 62 is rotated and decoupled from the door latch 60 provided on each of the doors 10 and 20. Therefore, the first door and the second door 10 and 20 and the door frames 50 are decoupled, and the first door and the second door 10 and 20 may slide.

FIG. 10 is a view exemplarily illustrating a process in which the hinge catcher 122 of the sliding door device for a vehicle according to the exemplary embodiment of the present disclosure is released from the door frame.

With reference to FIG. 10, cables C3 and C4 are provided on the swing handle portion 120 and connected to a hinge catcher 122. Tension is applied to the cables C3 and C4 by operation of the swing handle portion 120 so that the hinge catcher 122 may move in a direction perpendicular to the longitudinal direction of the vehicle body.

When the swing handle portion 120 is operated, the cable C3 at the upper side of the swing handle portion 120 is moved downward, and the cable C4 at the lower side of the swing handle portion 120 is moved upwards. Therefore, the hinge catcher 122 is pulled, and the hinge catcher 122 is decoupled from the door frame 50.

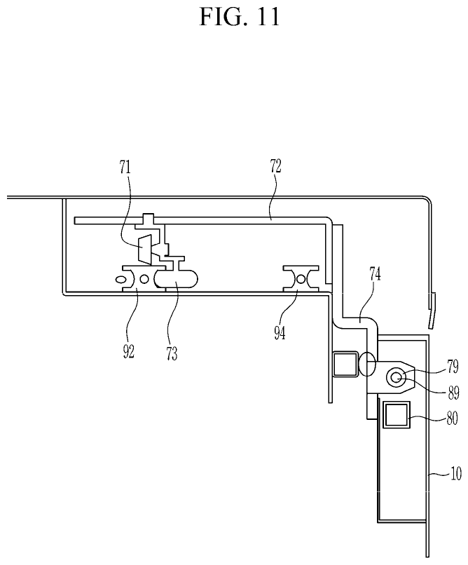

FIG. 11 is a cross-sectional view taken along line ‘C-C’ in FIG. 5.

With reference to FIG. 11, the door arm sliding assembly 70 provided at the upper side of the first door 10 includes the door arm 72 and the door arm bracket 74. The door roller 73 is provided on the lower surface of the door arm 72. The door roller 73 may roll by being in contact with the sliding rails 92 and 94 in accordance with the sliding motion of the first door 10. The sliding rails 92 and 94 may be provided as a pair of sliding rails 96 and 98 and each include a shape curved rearward toward the cab frame 30. Meanwhile, a rolling rail 71 may be further provided on the door arm 72. The rolling rail 77 including at least a roller may be in contact with an external portion of the sliding rail 92 and roll.

The door arm bracket 74 includes a locking pinhole 79. A locking pin 89 formed in the door fixing bar 80 provided at the upper side of the first door 10 may be inserted into or released from the locking pinhole 79.

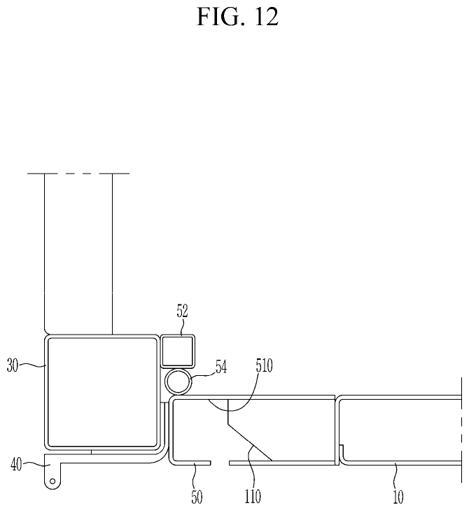

FIG. 12 is a cross-sectional view taken along line ‘B-B’ in FIG. 5.

With reference to FIG. 12, the door hinge 40 is provided on the cab frame 30, and the door hinge 40 is connected to the door frame 50. The door frame 50 may hingedly rotate relative to the cab frame 30 by the door hinge 40, and a protrusion 110 of the first door 10 may be inserted into and coupled to a guide hole 510 of the door frame 50 or decoupled from the door frame 50.

The first door 10, together with the door frame 50, may hingedly rotate relative to the cab frame 30 when the first door 10 is coupled to the door frame 50. Meanwhile, a body seal 54 may be provided between the cab frame 30 and the door frame 50 to mitigate impact caused by the hinged rotation of the door frame 50 relative to the cab frame 30. An opening frame 52 may be provided to restrict the hinged rotation. The above-mentioned structure of the first door 10 may be applied to the second door 20 in the same manner.

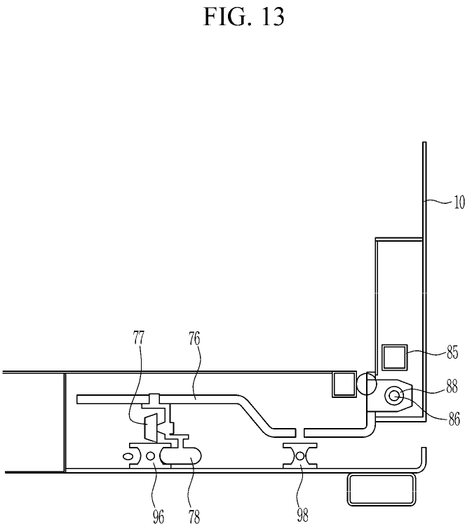

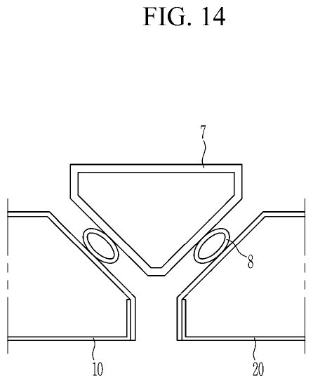

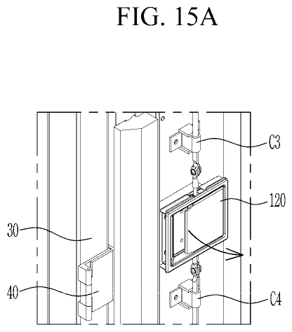

FIG. 13 is a cross-sectional view taken along line ‘D-D’ in FIG. 5.

With reference to FIG. 13, the door arm sliding assembly 75 provided at a lower side of the first door 10 includes a door arm 76. A door roller 78 is provided on a lower surface of the door arm 76. The door roller 78 may be in contact with sliding rails 96 and 98 and roll in accordance with the sliding motion of the first door 10. The sliding rails 96 and 98 may be provided as a pair of sliding rails 96 and 98 and each include a shape curved rearward toward the cab frame 30. Meanwhile, a rolling rail 77 may be further provided on the door arm 76. The rolling rail 77 including at least a roller may be in contact with an external portion of the sliding rail 96 and roll.

The door arm 76 includes a locking pinhole 88. A locking pin 86 formed in the door fixing bar 85 provided at the lower side of the first door 10 may be inserted into or released from the locking pinhole 88.

The structure of the door arm sliding assembly 75 provided at the lower side of the first door 10 may be applied to a lower side of the second door 20 in the same manner. FIG. 14 is a cross-sectional view taken along line ‘A-A’ in FIG. 5.

With reference to FIG. 14, a B-pillar 7 may be provided on a center portion of the chassis cab 5. The B-pillar 7 may extend in an upward and downward direction of the vehicle body and be configured to be detached from the chassis cab 5 or rotate. End portions of the first door and the second door 10 and 20, which face each other, may be coupled to the B-pillar 7 with a door seal 8 interposed therebetween. When the first door and the second door 10 and 20 slide and swing, the first door and the second door 10 and 20 are separated from the door seal 8 and separated from the B-pillar 7. The end portions of the first door and the second door 10 and 20, which face each other, may be provided in a form of inclined surfaces, and the inclined surfaces may be coupled to an inclined surface of the B-pillar 7 with the door seal 8 interposed therebetween.

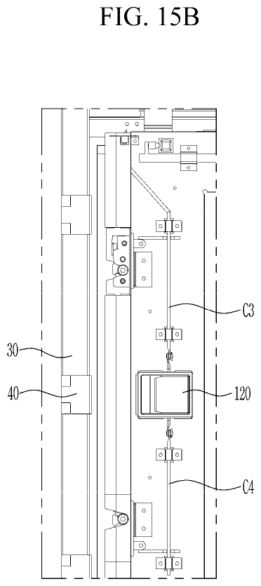

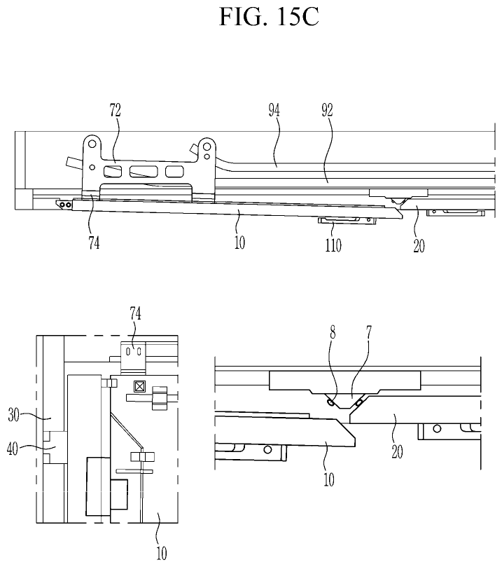

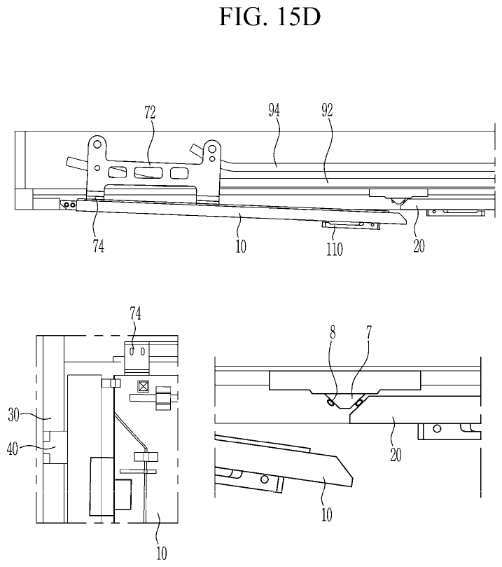

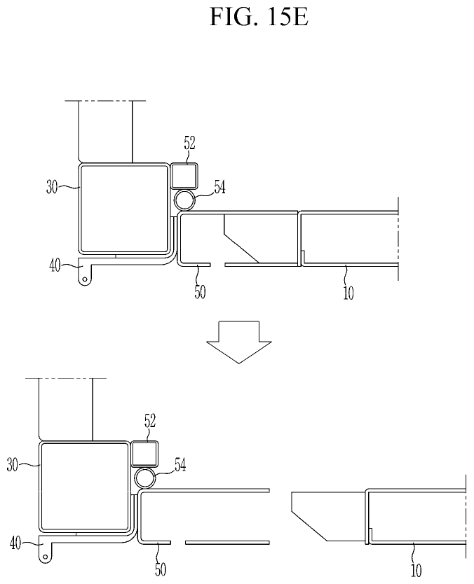

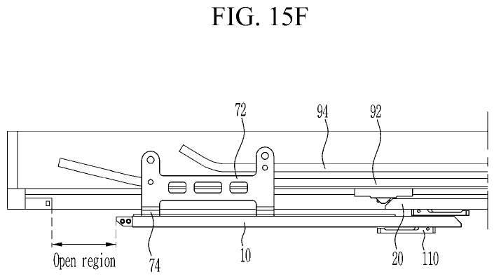

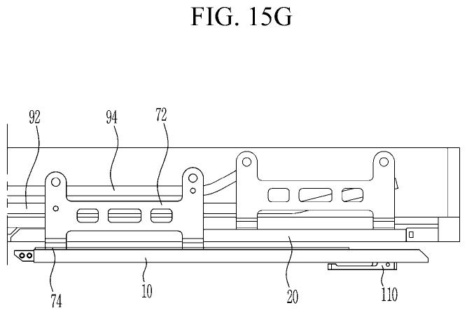

FIG. 15A, FIG. 15B, FIG. 15C, FIG. 15D, FIG. 15E, FIG. 15F and FIG. 15G are views exemplarily illustrating a process in which the door of the sliding door device for a vehicle according to the exemplary embodiment of the present disclosure slides.

With reference to FIG. 15A, FIG. 15B, FIG. 15C, FIG. 15D, FIG. 15E, FIG. 15F and FIG. 15G, the first door and the second door 10 and 20 may include the swing handle portions 120 that operate the first door and the second door 10 and 20 so that the first door and the second door 10 and 20 may swing about the cab frames 30 or may not swing. Furthermore, the first door and the second door 10 and 20 may include the hinge catchers 122 that operate so that the first door and the second door 10 and 20 are fixed to or released from the door frame 50 in conjunction with the operations of the swing handle portions 120. Furthermore, the cables C3 and C4, to which tension is applied by operation of the swing handle portion 120, may be connected to the swing handle portion 120. The cables C3 and C4 are connected to the hinge catcher 122 (FIG. 15A).

When the swing handle portion 120 is operated, the cable C3 at the upper side of the swing handle portion 120 is moved downward, and the cable C4 at the lower side of the swing handle portion 120 is moved upward (FIG. 15B). Therefore, the hinge catcher 122 is pulled, and the hinge catcher 122 is decoupled from the door frame 50.

Furthermore, a lever 116 is provided on the cables C3 and C4. The lever 116 is brought into contact with the door striker 62 by the movements of the cables C3 and C4 and rotates the door striker 62 so that the door striker 62 may be decoupled from the door latch 60. When the cables C3 and C4 are moved, the lever 116 also moves in the same direction, and the lever 116 comes into contact with and pushes the door striker 62 provided on the door frame 50. In the instant case, the door striker 62 is rotated and decoupled from the door latch 60 provided on each of the doors 10 and 20. Therefore, the first door and the second door 10 and 20 and the door frames 50 are decoupled, and the first door and the second door 10 and 20 may slide.

Because the door arm sliding assemblies 70 and 75 and the doors 10 and 20 are kept coupled, the first door and the second door 10 and 20 slide when the door arm sliding assemblies 70 and 75 move along the sliding rails 90, 92, 93, 94, 96, and 98 (FIG. 15C). Because the sliding rails 90, 92, 93, 94, 96, and 98 each include a shape curved rearward toward the cab frame 30, the doors 10 and 20 turn to protrude toward the outside of the vehicle body and then move rectilinearly as the doors 10 and 20 slide toward the B-pillar 7. When any one of the first door and the second door 10 and 20 slides, one door may move to overlap the front surface of the other door. In the instant case, the end portion of each of the doors 10 and 20 may be separated from the door seal 8, and thus each of the doors 10 and 20 may be decoupled from the B-pillar 7 (FIG. 15D).

The swing handle portions 120 are pulled so that the end portions of the doors 10 and 20 are decoupled from the door frames 50 (FIG. 15E). Furthermore, the doors 10 and 20 turn to protrude to the outside of the vehicle body while moving along the sliding rails 92 and 94 including curved shapes and then rectilinearly move (FIGS. 15F and 15G).

According to the exemplary embodiment of the present disclosure as described above, the door, which may slide and swing, is applied to the vehicle including the chassis cab configured for storing items. Therefore, the door open regions may be diversified, and the door opening width may be maximized so that items with various sizes may be loaded or unloaded, improving the usability.

Furthermore, the door may slide along the sliding rail including a curved shape, which may minimize a loss of the item storage space in the chassis cab and allow the item storage space to store a larger number of items.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A sliding door apparatus, which is provided at a lateral side of a chassis cab of a vehicle to slide in a longitudinal direction of the vehicle and configured to open or close an opening formed in the chassis cab, the sliding door apparatus comprising:
a pair of sliding rails provided on at least one of upper and lower portions of the chassis cab, extending in the longitudinal direction of the vehicle, and each being curved rearward toward a cab frame provided at a lateral side of the chassis cab; and
doors configured to be slidable along the sliding rails and positioned so that upper-end surfaces thereof are positioned without a level difference from an upper-end surface of the chassis cab in a state in which the doors are not slid, and so that the upper-end surfaces thereof protrude outwardly from the upper-end surface of the chassis cab in a state in which the doors are slid.

2. The sliding door apparatus of claim 1, wherein the pair of sliding rails includes an internal rail provided inside the vehicle, and an external rail provided outside the vehicle and extending in a direction parallel to the internal rail.

3. The sliding door apparatus of claim 1, wherein the internal rail is curved and includes a larger curvature than the external rail.

4. The sliding door apparatus of claim 1, wherein a door arm sliding assembly is provided on the upper portion or the lower portion of the chassis cab and configured to be coupled to or decoupled from the doors, and the door arm sliding assembly is slidable along the sliding rails.

5. The sliding door apparatus of claim 4, wherein the door arm sliding assembly includes:
a door arm configured to move along the sliding rails; and
a door arm bracket connected to the door arm and configured to be fixed to or released from the doors.

6. The sliding door apparatus of claim 5, wherein a door roller is provided on a lower surface of the door arm and contacts with the sliding rails and rolls in accordance with a sliding motion of the doors.

7. The sliding door apparatus of claim 1, wherein the doors include a sliding handle portion that operates the doors so that the doors slide along the sliding rails or do not slide.

8. The sliding door apparatus of claim 7, wherein the doors include a door fixing bar configured to move in a longitudinal direction of a vehicle body so that the doors are fixed to or released from the door arm sliding assembly in conjunction with an operation of the sliding handle portion.

9. The sliding door apparatus of claim 8, wherein a cable is connected to the door fixing bar, and the cable moves the door fixing bar in the longitudinal direction of the vehicle body when tension is applied to the cable by operation of the sliding handle portion.

10. The sliding door apparatus of claim 9, wherein the door fixing bar includes a locking pin, and the locking pin is coupled to or decoupled from the door arm sliding assembly by a movement of the door fixing bar.

11. The sliding door apparatus of claim 10, wherein the locking pin is inserted into or released from a locking pinhole provided in a door arm bracket of the door arm sliding assembly.

12. The sliding door apparatus of claim 1,
wherein the doors include first and second doors, and
wherein one of the first door and the second door slides and overlaps another door of the first door and the second door.

13. The sliding door apparatus of claim 12,
wherein door arm sliding assemblies are respectively provided on the first door and the second door, and
wherein a stopper is provided on the door arm sliding assemblies to restrict a sliding motion of an opposite door of the first door and the second door.

14. The sliding door apparatus of claim 1,
wherein each of the doors include a protrusion and a door frame provided on the cab frame includes guide holes, and
wherein the protrusions of the doors are selectively inserted into and coupled to the guide holes.

15. The sliding door apparatus of claim 11,
wherein a B-pillar is provided on a center portion of the chassis cab, and the B-pillar extends in an upward and downward direction of a vehicle body and is configured to be detached from the chassis cab or rotate, and
wherein an upper-end surface of the B-pillar includes an inclined shape corresponding to shapes of upper-end surfaces of end portions of the doors.

16. A sliding door apparatus, which is provided at a lateral side of a chassis cab of a vehicle to slide in a longitudinal direction of the vehicle and configured to open or close an opening formed in the chassis cab, the sliding door apparatus comprising:
sliding rails provided on at least one of upper and lower portions of the chassis cab
a first door and a second door connected to be slidable in the longitudinal direction of the vehicle along the sliding rails so that the first door and the second door overlap each other,
wherein end portions of the first door and the second door, which face each other, have inclined shapes, and
wherein the first door and the second door are positioned so that upper-end surfaces thereof are positioned without a level difference from an upper-end surface of the chassis cab in a state in which the first door and the second door are not slid, and the first door and the second door are positioned so that the upper-end surfaces thereof protrude outwardly from the upper-end surface of the chassis cab in a state in which the first door and the second door are slid.

17. The sliding door apparatus of claim 16, wherein a B-pillar is provided on a center portion of the chassis cab, and the B-pillar extends in an upward and downward direction of the vehicle body and is configured to be detached from the chassis cab or rotate.

18. The sliding door apparatus of claim 17, wherein an upper-end surface of the B-pillar includes an inclined shape corresponding to shapes of the upper-end surfaces of the end portions of the first door and the second door.

19. The sliding door apparatus of claim 18, wherein the end portions of the first door and the second door, which face each other, are coupled to the B-pillar with a door seal interposed therebetween.

20. The sliding door apparatus of claim 16,
wherein each of the first door and the second door include a protrusion and a door frame provided on a cab frame mounted at a lateral side of the chassis cab includes guide holes, and
wherein the protrusions of the first door and the second door are selectively inserted into and coupled to the guide holes.
